(19) United States
(12) Patent Application Publication
(10) Pub. No.: US 2018/0086918 A1
(43) Pub. Date: Mar. 29, 2018

(54) MIXTURES OF REACTIVE DYES AND THEIR USE FOR THE DYING OR PRINTING FIBRE MATERIALS

(71) Applicant: HUNTSMAN ADVANCED MATERIALS (SWITZERLAND) GMBH, Basel (CH)

(72) Inventors: Jean-François LANDRE, Mulhouse (FR); Hubert Jean-Luc CHRISTNACHER, Dietwiller (FR); Fanny EHRET, Reiningue (FR); Patrick BONI, Rantzwiller (FR)

(21) Appl. No.: 15/573,201

(22) PCT Filed: Apr. 28, 2016
(86) PCT No.: PCT/EP2016/059463

§ 371 Date: Nov. 10, 2017

(30) Foreign Application Priority Data
May 12, 2015 (EP) 15167324.1

(51) Int. Cl. C09B 67/22; C09B 62/44; C09D 11/037; C09D 11/328; D06P 1/384; D06P 3/66; D06P 5/30

(52) U.S. Cl. CPC C09B 67/0052; C09B 62/4413; C09D 11/037; D06P 5/30; D06P 1/384; D06P 3/666; C09D 11/328

(57) ABSTRACT

A dye mixture comprising at least one dye of formula

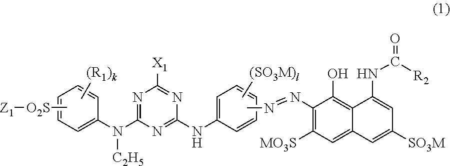

and at least one dye from the group of formulae

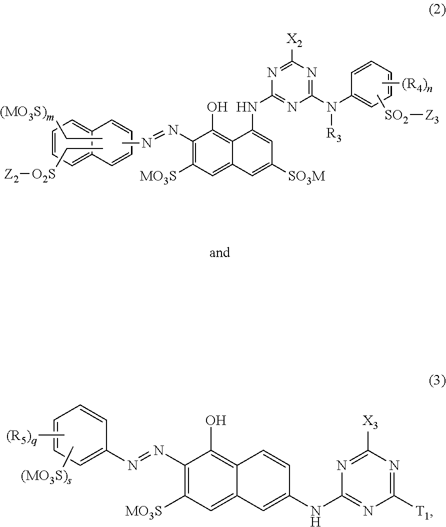

wherein
(R₁)ₖ denotes k identical or different substituents from the group C₁-C₄alkoxy, C₁-C₄alkyl and sulfo,
R₂ is hydrogen or C₁-C₄alkyl,
R₃ is hydrogen or C₁-C₄alkyl,
(R₄)ₙ denotes n identical or different substituents from the group C₁-C₄alkoxy, C₁-C₄alkyl and sulfo,
(R₅)_{q} denotes q identical or different substituents from the group C₁-C₄alkoxy and C₁-C₄alkyl,
X₁, X₂ and X₃ are each independently of the others halogen, 3-carboxypyridin-1-yl or 3-carbamoylpyridin-1-yl,
T₁ is a fibre-reactive radical of formula

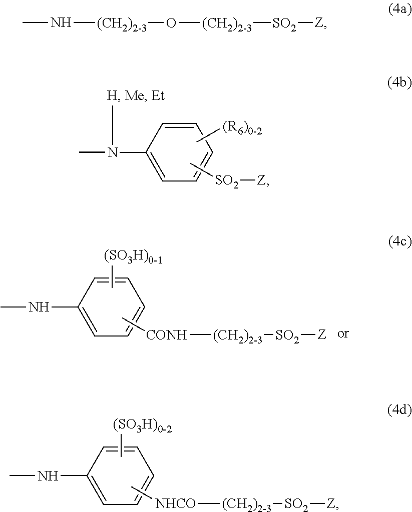

wherein
(R₆)₀₋₂ denotes from 0 to 2 identical or different substituents from the group C₁-C₄alkyl, C₁-C₄alkoxy and sulfo,
Me means methyl, and Et means ethyl,
Z, Z₁, Z₂ and Z₃ are each independently of the others vinyl or a radical —CH₂—CH₂—U and U is a group removable under alkaline conditions,
M is hydrogen, an alkali metal or one equivalent of an alkaline earth metal,
k, n and q are each independently of the others the number 0, 1 or 2, and
l, m and s are each independently of the others the number 1 or 2,
are suitable especially for the dyeing or printing of cellulosic fibre materials, exhibit good build-up, and yield dyeings and prints having good reproducibility and good all-round fastness properties.

### FIELD OF INVENTION

The present invention relates to mixtures of reactive dyes that are suitable for the dyeing or printing of nitrogen-containing or hydroxy-group-containing fibre materials and yield on such materials dyeings or prints having good reproducibility and good all-round fastness properties. The present invention relates also to a method for the dyeing or printing of nitrogen-containing or hydroxy-group-containing fibre materials wherein the reactive dye mixtures according to the invention are used.

### BACKGROUND OF THE INVENTION

Over the past years, many countries have committed to improve the quality of the environment by saving natural resources and reducing the emission of substances which are harmful to the climate. Funds are provided by the governments to support the industry in achieving these goals. The consumer is asking for environmentally friendly textile products which are produced in accordance with highest ecological standards. Brands and retailers are conveying these demands into real requirements and textile manufacturers are continuously improving their production excellence by investing in modern equipment and selecting environmental friendly chemical substances.

As a result, there is a huge demand for novel reactive dyes and dye mixtures that are suitable for the reproducible dyeing and printing of fibre materials which fulfill highest ecological and economical requirements while still providing dyeings of the desired colour shades with good fastness properties, such as wash and water fastness and perspiration fastness. Suitable reactive dyes should provide a unique combinability and a low sensitivity to various dyeing parameters. Furthermore, they should have sufficient substantivity and at the same time have good ease of washing off of unfixed dye. They should also exhibit a good tinctorial yield and high reactivity, the objective being to provide especially dyeings having high degrees of fixing. In many cases, the build-up behaviour of reactive dyes is insufficient to meet the demands being made, especially when dyeing very deep shades.

The present invention is therefore based on the problem of providing new mixtures of reactive dyes that are suitable especially for the reproducible dyeing and printing of fibre materials in the desired colour shades and fulfill the above indicated requirements to the highest possible extent. The dye mixtures and dyes should also yield dyeings having good all-round fastness properties, for example fastness to light and to wetting.

### DETAILED DESCRIPTION

The present invention accordingly relates to a dye mixture comprising at least one dye of formula

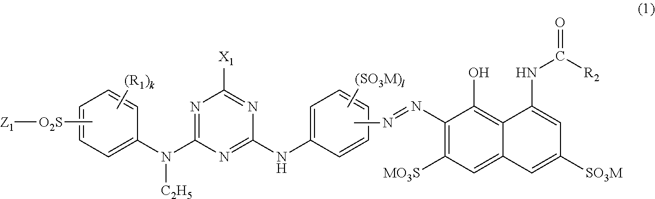

and at least one dye from the group of formulae

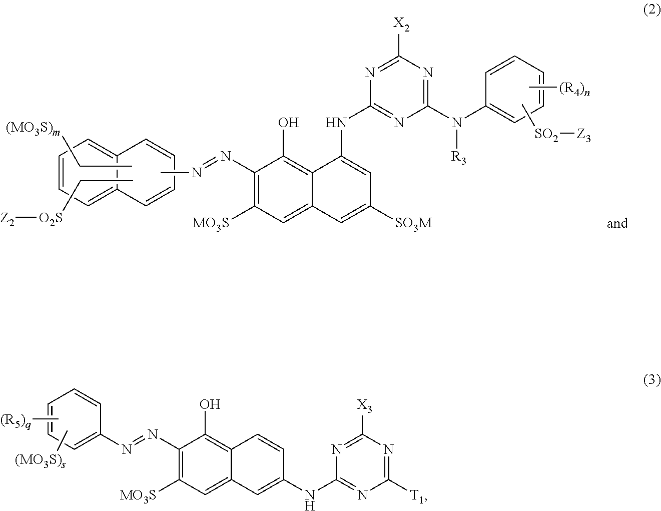

wherein
(R₁)ₖ denotes k identical or different substituents from the group C₁-C₄alkoxy, C₁-C₄alkyl and sulfo,
R₂ is hydrogen or C₁-C₄alkyl,
R₃ is hydrogen or C₁-C₄alkyl,
(R₄)ₙ denotes n identical or different substituents from the group C₁-C₄alkoxy, C₁-C₄alkyl and sulfo,
(R₅)_{q} denotes q identical or different substituents from the group C₁-C₄alkoxy and C₁-C₄alkyl,
X₁, X₂ and X₃ are each independently of the others halogen, 3-carboxypyridin-1-yl or 3-carbamoylpyridin-1-yl,
T₁ is a fibre-reactive radical of formula

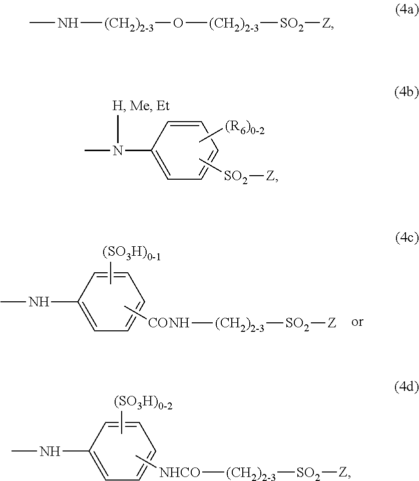

wherein
(R₆)₀₋₂ denotes from 0 to 2 identical or different substituents from the group C₁-C₄alkyl, C₁-C₄alkoxy and sulfo,
Me means methyl, and Et means ethyl,
Z, Z₁, Z₂ and Z₃ are each independently of the others vinyl or a radical —CH₂—CH₂—U and U is a group removable under alkaline conditions,
M is hydrogen, an alkali metal or one equivalent of an alkaline earth metal,
k, n and q are each independently of the others the number 0, 1 or 2, and
l, m and s are each independently of the others the number 1 or 2.

The dyes of formulae (1), (2) and (3) are fiber reactive, i.e. the dyes of formulae (1), (2) and (3) contain at least two fibre-reactive substituents.

The dye mixtures according to the invention comprise at least one dye of formula (1) and at least one dye from the group of formulae (1) and (2). In one embodiment of the present invention, the dye mixtures comprise at least one dye of formula (1), e.g. one, two or three, preferably one dye of formula (1), and at least one dye of formula (2), e.g. one, two or three, preferably one dye of formula (2). In another embodiment of the present invention, the dye mixtures comprise at least one dye of formula (1), e.g. one, two or three, preferably one dye of formula (1), and at least one dye of formula (3), e.g. one, two or three, preferably one dye of formula (3).

In the radical of formula (4b), Me is the methyl radical and Et is the ethyl radical. Beside hydrogen, the said radicals come into consideration as substituents bonded to the nitrogen atom.

The dyes of formulae (1) and (2) contain at least 3, preferably 3 or 4, and especially 3 sulfo groups. The dye of formula (3) contains at least 2, preferably 2 or 3, and especially 3 sulfo groups. Sulfo groups —SO₃M are present either in free acid form (M is hydrogen) or, preferably, in salt form. Suitable salts are, for example, alkali metal or alkaline earth metal salts. Further salts which come into consideration are ammonium salts, salts of an organic amine, or mixtures thereof. Examples that may be mentioned are sodium, lithium, potassium or ammonium salts, a mono-, di- or tri-ethanolamine salt or mixed Na/Li or Na/Li/NH₄ salts.

As C₁-C₄alkyl there come into consideration for R₁, R₄, R₅ and R₆ each independently of the others e.g. methyl, ethyl, propyl, isopropyl, n-butyl, sec-butyl, tert-butyl and isobutyl, preferably methyl and ethyl, and more preferably methyl.

As C₁-C₄alkyl there come into consideration for R₃ e.g. methyl, ethyl, propyl, isopropyl, n-butyl, sec-butyl, tert-butyl and isobutyl, preferably methyl and ethyl, and more preferably ethyl.

As C₁-C₄alkyl there come into consideration for R₂ e.g. methyl, ethyl, propyl, isopropyl, n-butyl, sec-butyl, tert-butyl and isobutyl, preferably methyl, ethyl and propyl, and more preferably ethyl.

As C₁-C₄alkoxy there come into consideration for R₁, R₄, R₅ and R₆ each independently of the others e.g. methoxy, ethoxy, n-propoxy, isopropoxy, n-butoxy and isobutoxy, preferably methoxy and ethoxy, and more preferably methoxy.

In an interesting embodiment R₂ is methyl, ethyl or propyl, preferably ethyl.

In an interesting embodiment R₃ is ethyl.

Preferably, (R₅)_{q} denotes 1 or 2 identical or different substituents from the group methoxy and methyl, more preferably (R₅)_{q} denotes methyl. Preferably, q is the number 1.

Preferably, k and n are each the number 0. Preferably, l is the number 1. Preferably, m is the number 1. Preferably, s is the number 2.

As halogen there come into consideration for X₁, X₂ and X₃ each independently of the others e.g. fluorine, chlorine and bromine, preferably fluorine and chlorine.

Preferably, X₁, X₂ and X₃ are halogen.

In one embodiment of the present invention X₁ is fluorine. In one embodiment of the present invention X₂ is chlorine. In one embodiment of the present invention X₃ is fluorine. In an interesting embodiment X₁ and X₃ are fluorine and X₂ is chlorine.

As leaving group U there comes into consideration, for example, —Cl, —Br, —F, —OSO₃H, —SSO₃H, —OCO—CH₃, —OPO₃H₂, —OCO—C₆H₅, —OSO₂—C₁-C₄alkyl or —OSO₂—N(C₁-C₄alkyl)₂. U is preferably a group of the formula —Cl, —OSO₃H, —SSO₃H, —OCO—CH₃, —OCO—C₆H₅ or —OPO₃H₂, especially —Cl or —OSO₃H.

Examples of suitable radicals Z, Z₁, Z₂ and Z₃ are accordingly vinyl, β-bromo- or β-chloroethyl, β-acetoxyethyl, β-benzoyloxyethyl, β-phosphatoethyl, β-sulfatoethyl and β-thiosulfatoethyl. Z, Z₁, Z₂ and Z₃ are preferably vinyl, β-chloroethyl or β-sulfatoethyl.

In one embodiment of the present invention T₁ is a fibre-reactive radical of formula

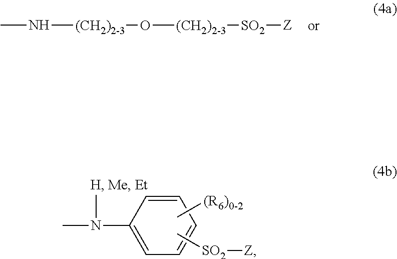

wherein
Me means methyl, and Et means ethyl,
(R₆)₀₋₂ denotes from 0 to 2 identical or different substituents from the group methoxy, methyl and sulfo, and
Z is vinyl, β-sulfatoethyl or β-chloroethyl,
preferably a radical of formula (4a), wherein Z is vinyl, β-sulfatoethyl or β-chloroethyl, preferably, vinyl or β-chloroethyl.

The radical of formula (4b) is, for example, a radical of formula

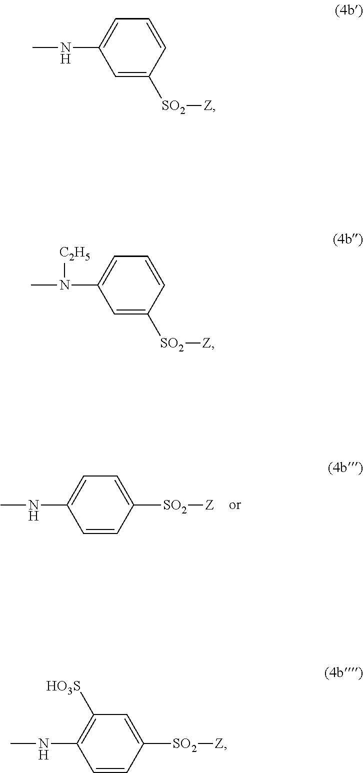

wherein Z has the definitions and preferred meanings given above.

In a particular embodiment, the dye of formula (1) corresponds to a dye of formula

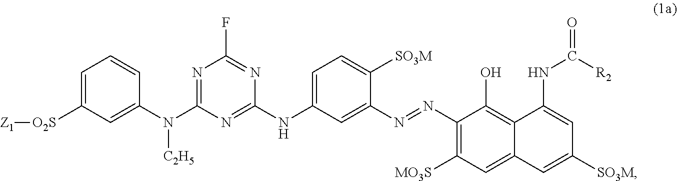

wherein
R₂ is methyl, ethyl or propyl, preferably ethyl,
M is hydrogen, an alkali metal or one equivalent of an alkaline earth metal, and
Z₁ is vinyl or β-sulfatoethyl.

The dye of formula (1) in its free acid form is, for example, a dye of the formula

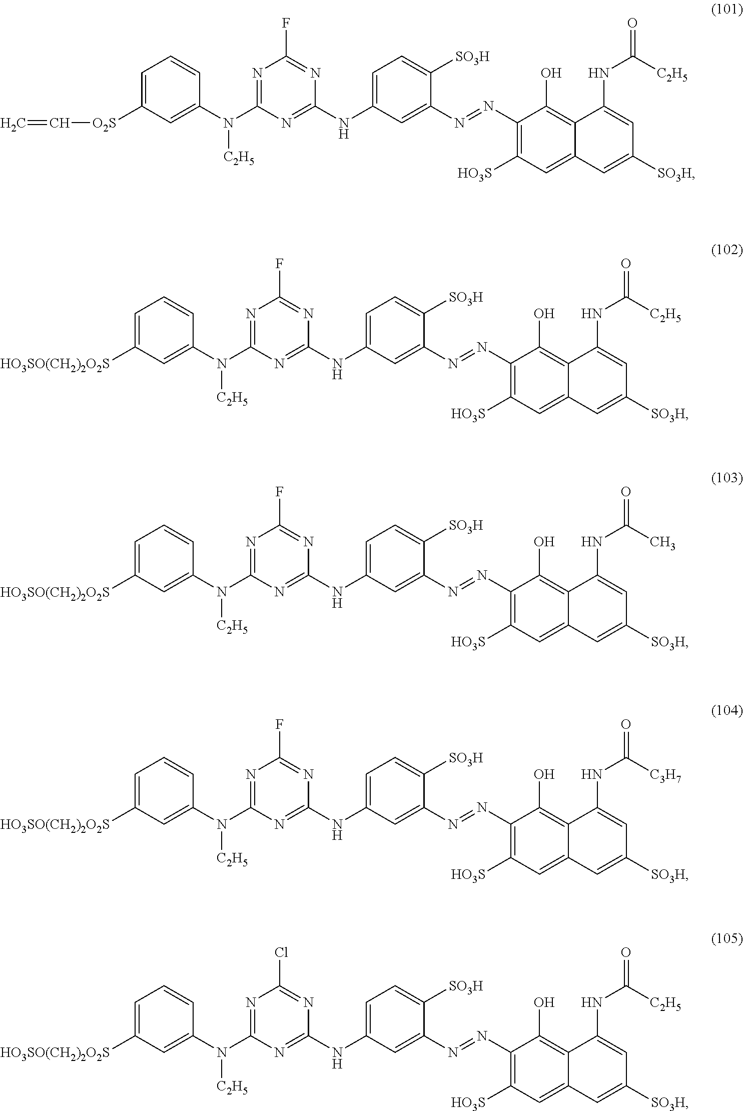

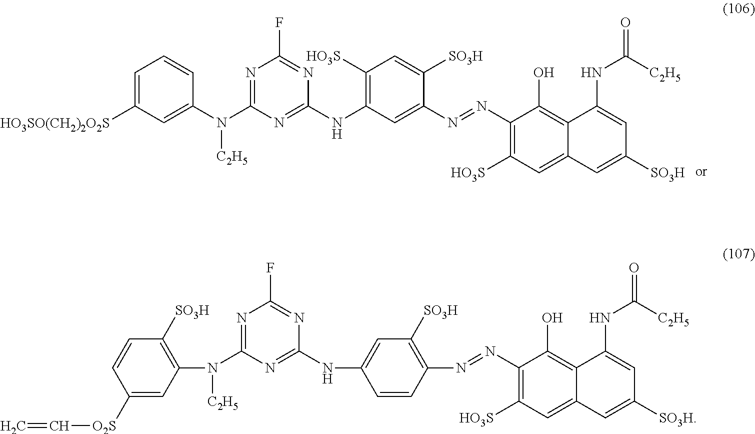

In one embodiment the dye mixture according to the present invention comprises as the dye of formula (1) the dye of formula (101) and/or (102).

The dye of formula (2) in its free acid form is, for example, a dye of the formula

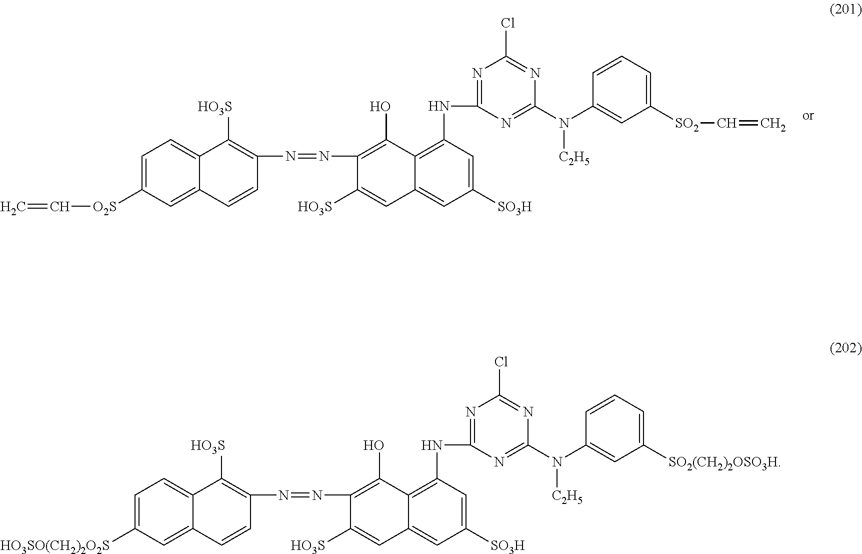

The dye of formula (3) in its free acid form is, for example, a dye of the formula

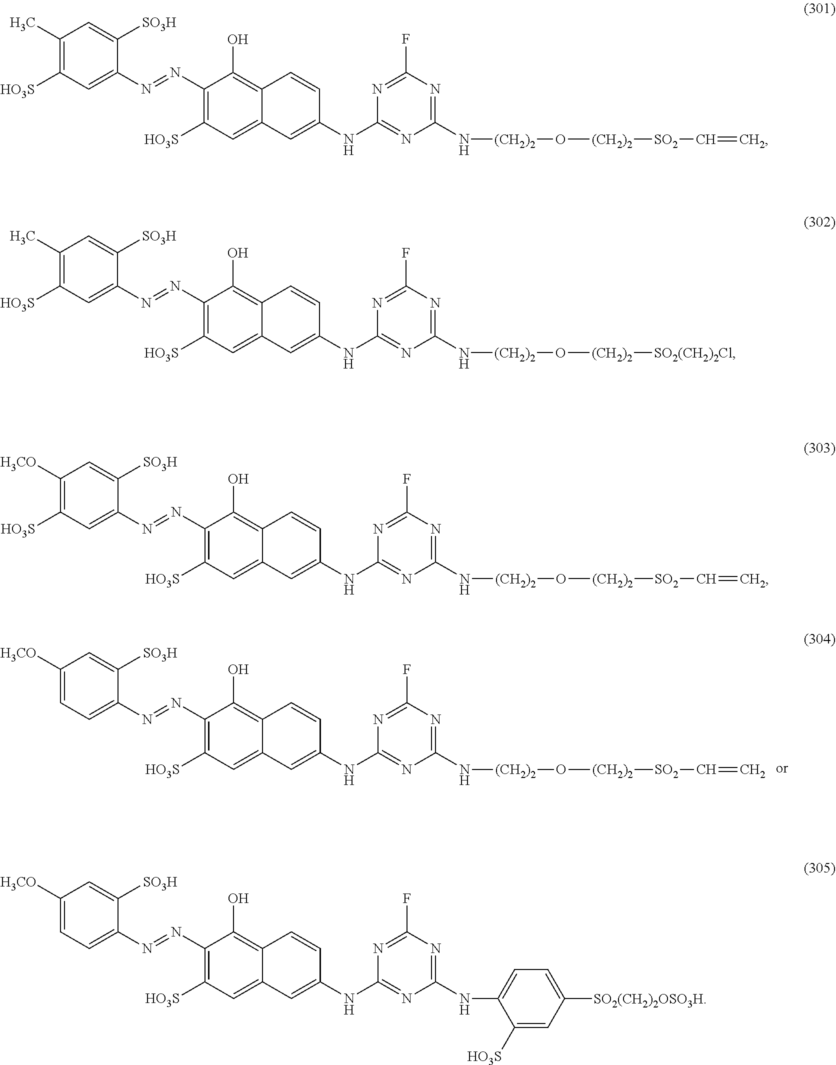

In one embodiment the dye mixture according to the present invention comprises as the dye of formula (3) the dye of formula (301) and/or (302).

The dyes of formulae (1), (2) and (3) are known in some cases, or they can be prepared in accordance with processes known per se as described, for example, in U.S. Pat. No. 4,667,022, U.S. Pat. No. 5,298,607, EP-A-94055 and U.S. Pat. No. 4,754,023.

The present invention also relates to the novel reactive dye of formula

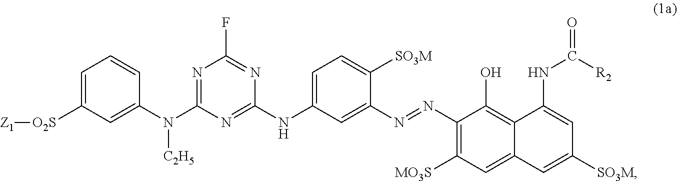

wherein
R₂ is methyl, ethyl or propyl, preferably ethyl,
M is hydrogen, an alkali metal or one equivalent of an alkaline earth metal, and
Z₁ is vinyl or β-sulfatoethyl.

The reactive dye of formula (1a) can be obtained, for example, by reacting with one another, in any order,

an amino azo compound of formula

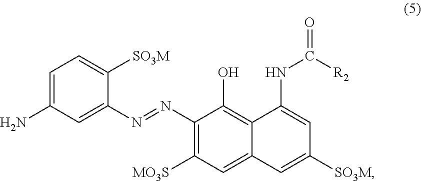

an amino compound of formula

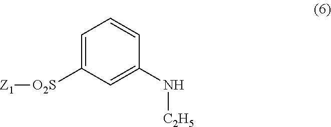

and
a triazine compound of formula

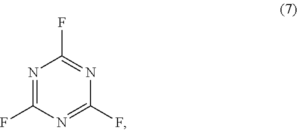

wherein
R₂, M and Z₁ each have the meanings and preferred meanings defined above.

A variant of the process comprises first condensing one of the compounds of formulae (5) and (6) with cyanuric fluoride of formula (7) and reacting the resulting reaction product with the other compound of formulae (5) and (6), which has been condensed beforehand with cyanuric fluoride of formula (7). Alternatively, the precursor of the amino azo compound of formula (5) 1,3-diamino-benzene-4-sulfonic acid is condensed with the primary condensation product of the amino compound of formula (6) and cyanuric fluoride of formula (7), and the resulting secondary condensation product is subsequently diazotated and coupled in analogy to the process described in Example 6 of U.S. Pat. No. 5,298,607 (cols 37 and 38), which hereby is incorporated by reference.

In the preparation of the reactive dye of formula (1a) there are used, for example, equimolar amounts of the compounds of formulae (5), (6) and (7).

The condensation reactions between the compound of formula (5), the precursor of the compound of formula (5), the compound of formula (6) and cyanuric fluoride of formula (7) are generally carried out analogously to known processes, usually in aqueous solution at temperatures of, for example, from 0 to 70° C. and a pH of, for example, from 3 to 10. The compounds of formulae (5) and (6), as well as the cyanuric fluoride of formula (7) are known or can be prepared analogously to known compounds.

The end product can optionally also be subjected to a transformation reaction. Such a transformation reaction is, for example, the conversion of a vinylatable reactive group Z, Z₁, Z₂ or Z₃ into its vinyl form by treatment with dilute sodium hydroxide solution, such as, for example, the conversion of the β-chloroethylsulfonyl radical or β-sulfatoethylsulfonyl radical into the vinylsulfonyl radical. Such reactions are known per se. Those transformation reactions are generally effected in a neutral to alkaline medium at a temperature of, for example, from 20 to 70° C., at a pH of, for example, from 6 to 14.

The dye mixture according to the invention can be prepared, for example, by mixing the individual dyes together. The mixing procedure is effected, for example, in suitable mills, e.g. ball mills or pin mills, as well as in kneaders or mixers. The dye mixtures according to the invention can also be prepared, for example, by dissolving the reactive dyes of formulae (1), (2) and (3) directly in the dyebath or the printing medium. The amount of the individual reactive dyes is governed by the shade to be obtained. The dye of formula (1) and the dye of formula (2) or (3), or the dye of formula (1) and the dyes of formulae (2) and (3), are present in the dye mixture according to the present invention in a ratio by weight of, for example, from 1:99 to 99:1, 5:95 to 95:5, 10:90 to 90:10, 25:75 to 75:25, 30:70 to 70:30 and 35:65 to 65:35. In one embodiment, the dye of formula (1) and the dye of formula (2) are present in the dye mixture in a ratio by weight of from 75:25 to 65:35, preferably of 70:30. In another embodiment, the dye of formula (1) and the dye of formula (3) are present in the dye mixture in a ratio by weight of from 80:20 to 70:30, preferably of 75:25.

The reactive dyes of formulae (1), (2) and (3) and accordingly also the dye mixtures according to the invention may comprise further additives, for example sodium chloride or dextrin.

If desired, the reactive dyes of formulae (1), (2) and (3) and the dye mixtures according to the invention may comprise further auxiliaries which, for example, improve handling or increase storage stability, such as buffers, dispersants or anti-dusts. Such auxiliaries are known to the person skilled in the art.

The dye mixture and dyes according to the invention are suitable for the dyeing and printing of an extremely wide variety of materials, especially hydroxy-group-containing or nitrogen-containing fibre materials. Examples thereof are paper, silk, leather, wool, polyamide fibres and polyurethanes as well as, especially, cellulosic fibre materials of all kinds. Such fibre materials are, for example, natural cellulose fibres, such as cotton, linen and hemp, as well as cellulose and regenerated cellulose. The dye mixtures and dyes according to the invention invention are also suitable for the dyeing or printing of hydroxy-group-containing fibres that are contained in blend fabrics, for example mixtures of cotton with polyester fibres or polyamide fibres.

The said textile fibre material may be in an extremely wide variety of processing forms, such as, for example, in the form of fibres, yarn, woven fabric or knitted fabric.

Accordingly, the present invention relates also to a method for the dyeing or printing of hydroxy-group-containing or nitrogen-containing fibre materials, especially cellulosic fibre materials, which method comprises using at least one dye, for example one, two or three dyes, preferably one dye, of the above-mentioned formula (1), together with at least one dye, for example one, two or three dyes, preferably one dye, of the above-mentioned formula (2), and/or at least one dye, for example one, two or three dyes, preferably one dye, of the above-mentioned formula (3), wherein R₁, R₂, R₃, R₄, R₅, R₆, X₁, X₂, X₃, T₁, Me. Et, Z, Z₁, Z₂, Z₃, M, k, m, n, q. l and s each have the meanings and preferred meanings defined above.

The dye mixtures or dyes according to the invention are suitable for customary dyeing and printing methods and can be applied to the fibre material and fixed thereto in a wide variety of ways, especially in the form of aqueous dye solutions or print pastes.

The method for dyeing and printing of hydroxy-group-containing or nitrogen-containing fibre materials according to the invention can be carried out in accordance with customary dyeing and printing methods, for example, according to the so-called cold pad-batch process, in which the dye is applied, together with the alkali, on the padder and is then fixed by storage for several hours at about room temperature, for example, from 25 to 35° C. Preferably, the method for dyeing and printing according to the invention is carried out according to the exhaust-dyeing method, in which the goods are impregnated with aqueous, optionally salt-containing dye solutions, and the dyes are fixed after an alkali treatment or in the presence of alkali, optionally under the action of heat.

The dye liquors or print pastes, in addition to containing water and the dyes, may also comprise further additives, for example shading dyes known per se, salts, buffer substances, wetting agents, anti-foams, levelling agents or agents that influence the properties of the textile material, for example softeners, additives for flame-resistant finishes or dirt-, water- or oil-repellants, as well as water-softeners and natural or synthetic thickeners, e.g. alginates or cellulose ethers.

The amounts in which the dye mixtures or the individual dyes are used in the dyebaths or print pastes can vary within wide limits in dependence upon the desired depth of shade; in general, amounts of from 0.01 to 15% by weight, especially from 0.1 to 10% by weight, based on the goods being dyed or on the print paste, have proved advantageous.

The inventive dye mixtures or dyes used in accordance with the method of the present invention are distinguished by high and uniform colour build-up, good exhaustion and fixing behaviour, good constancy of shade even in different concentrations, a low sensitivity to various dyeing parameters and, in particular, very good combinability. Dyeing times can be reduced. Furthermore, they have sufficient substantivity and at the same time have good ease of washing off of unfixed dye and can advantageously be applied at short liquor ratios, for example, at a liquor ratio of from 1:4 to 1:6, preferably, 1:6. The dyeings and prints produced in accordance with the method of the invention exhibit brilliant shades of very good fastness properties, such as fastness to washing, to water, to sea water, to cross-dyeing and to perspiration, as well as good fastness to chlorine, to pleating, to hot-pressing and to rubbing, and good reproducibility.

The dye mixtures and dyes according to the invention are also suitable as colorants for use in recording systems. Such recording systems are, for example, commercially available ink-jet printers for paper or textile printing, or writing implements, such as fountain pens or ball-point pens, and especially ink-jet printers. For that purpose, the dye mixture according to the invention or the dyes according to the invention are first converted into a form suitable for use in recording systems. A suitable form is, for example, an aqueous ink comprising at least one dye of the dye mixture according to the invention as colorant. The inks can be prepared in customary manner by mixing together the individual constituents customary in ink-jet printing in the desired amount of water. Conveniently, individual inks, comprising at least one dye of formulae (1), (2) and (3), are used in a multi color ink-jet printer and mixing is effected on the substrate by digital printing. For example, one ink comprises a dye of formula (1), and another ink comprises a dye of formula (2), or one ink comprises a dye of formula (1), and another ink comprises a dye of formula (3).

Examples of substrates that come into consideration for ink-jet printing, in addition to paper or plastics films, include the above-mentioned hydroxy-group-containing or nitrogen-containing fibre materials, especially cellulosic fibre materials. The substrates are preferably textile fibre materials.

The following Examples serve to illustrate the invention. Unless otherwise indicated, temperatures are given in degrees Celsius, parts are parts by weight and percentages relate to percent by weight. Parts by weight relate to parts by volume in a ratio of kilograms to litres.

### Example 1

A bleached cotton tricot fabric is introduced at 60° C. into an aqueous dyebath with a liquor ratio of 10:1 which contains 55 g/l of sodium chloride, and 2.75% of a dyestuff mixture containing 69.0% of the reactive dye of formula (102) and 31% of the reactive dye of formula (201). After 30 minutes at 60° C. 16.0 g/l of calcined sodium carbonate are added to the dyebath. Dyeing is continued for 30 minutes. The dyed fabric is taken out of the dyeing liquor and submitted to a washing treatment by rinsing the fabric for 10 minutes in a water bath with a liquor ratio of 6:1 at 60° C. This washing treatment is repeated another three times. A brilliant pink shaded fabric with a colour depth of 1/1 SD (standard depth according to ISO 105-A-1984 (E)) is obtained.

### Comparative Example 1

A bleached cotton tricot fabric is introduced at 60° C. into an aqueous dyebath with a liquor ratio of 10:1 which contains 55 g/l of sodium chloride, and 2.70% of a dyestuff mixture containing 75.0% of the red dyeing reactive dye of formula

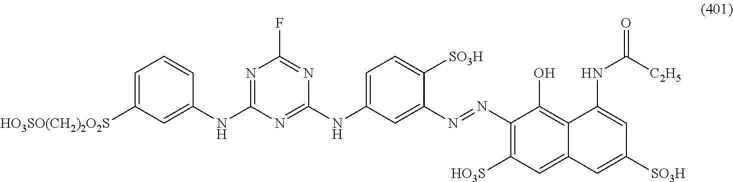

and 25% of the red dyeing reactive dye of formula (201). After 30 minutes at 60° C. 16.0 g/l of calcined sodium carbonate are added to the dyebath. Dyeing is continued for 30 minutes. The dyed fabric is taken out of the dyeing liquor and submitted to a washing treatment by rinsing the fabric for 10 minutes in a water bath with a liquor ratio of 6:1 at 60° C. This washing treatment is repeated another three times. A brilliant pink shaded fabric with a colour depth of 1/1 SD (standard depth according to ISO 105-A-1984 (E)) is obtained.

The washed fabrics obtained according to Example 1 and Comparative Example 1 are subjected to the following colour fastness tests:

(a) Washing C1S at 60° C. according to ISO 105-C06,
(b) Water severe according to ISO 105-E01,
(c) Perspiration alkaline according to ISO 105-E04,
(d) Perspiration acid according to ISO 105-E04.

Changes in colour are determined according to the Grey Scale. Higher ratings indicate superior fastness properties. The data in Table 1 demonstrate that the fabric dyed with the inventive dyestuff mixture according to Example 1 exhibits superior fastness properties.

TABLE 1
Fastness properties

| | Example 1 | | Comp Example 1 | |
|---|---|---|---|---|
| Wash treatment | CO | PA | CO | PA |
| (a) Washing C1S at 60° C. | 4-5 | 4-5 | 3-4 | 4-5 |
| (b) Water severe | 3-4 | 4 | 3 | 3 |
| (c) Perspiration alkaline | 3 | 4-5 | 2-3 | 4 |
| (d) Perspiration acid | 3 | 4 | 2-3 | 3 |

### Example 2

A bleached cotton tricot fabric is introduced at 60° C. into an aqueous dyebath with a liquor ratio of 10:1 which contains 60 g/l of sodium chloride, and 2.70% of a dyestuff mixture containing 75.0% of the reactive dye of formula (102) and 25% of the reactive dye of formula (301). After 30 minutes at 60° C. 5.0 g/l of calcined sodium carbonate and 1.5% of sodium hydroxide 36° Be are added to the dyebath. Dyeing is continued for 30 minutes. The dyed fabric is taken out of the dyeing liquor and submitted to a washing treatment by rinsing the fabric for 10 minutes in a water bath with a liquor ratio of 6:1 at 60° C. This washing treatment is repeated another three times. A brilliant scarlet shaded fabric with a colour depth of 1/1 SD is obtained.

### Example 3

A bleached cotton tricot fabric is introduced at 60° C. into an aqueous dyebath with a liquor ratio of 10:1 which contains 60 g/l of sodium chloride, and 2.70% of a dyestuff mixture containing 70.0% of the reactive dye of formula (103) and 30% of the reactive dye of formula (201). After 30 minutes at 60° C. 5.0 g/l of calcined sodium carbonate and 1.5% of sodium hydroxide 36° Be are added to the dyebath. Dyeing is continued for 30 minutes. The dyed fabric is taken out of the dyeing liquor and submitted to a washing treatment by rinsing the fabric for 10 minutes in a water bath with a liquor ratio of 6:1 at 60° C. This washing treatment is repeated another three times. A brilliant pink shaded fabric with a colour depth of 1/1 SD is obtained.

### Example 4

A brilliant scarlet shaded fabric with a colour depth of 1/1 SD is likewise obtained by repeating the process of Example 2, but using instead of 2.70% of a dyestuff mixture containing 75.0% of the reactive dye of formula (102), and 25% of the reactive dye of formula (301), 2.70% of a dyestuff mixture containing 75.0% of the reactive dye of formula (102), and 25% of the reactive dye of formula (303).

### Printing Procedure I

3 parts of a dyestuff mixture containing 69.0% of the reactive dye of formula (102), and 31% of the reactive dye of formula (201) are sprinkled, with rapid stirring, into 100 parts of a stock thickener containing 50 parts of 5% sodium alginate thickener, 27.8 parts of water, 20 parts of urea, 1 part of sodium m-nitrobenzenesulfonate and 1.2 parts of sodium hydrogen carbonate. The print paste so obtained is used to print a cotton fabric, and the resulting printed material is dried and steamed in saturated steam for 2 minutes at 102° C. The printed fabric is then rinsed, if desired soaped at the boil and rinsed again, and subsequently dried.

### Printing Procedure II

(a) Mercerised cotton-satin is padded using a liquor containing 30 g/l of sodium carbonate and 50 g/l of urea (liquor uptake 70%) and dried.
(b) The cotton-satin pre-treated according to Step (a) is printed using an aqueous ink containing
15% of a dyestuff mixture containing 69.0% of the reactive dye of formula (102), and 31% of the reactive dye of formula (201),
15% of 1,2-propylene glycol and
70% of water
   using a drop-on-demand inkjet head (bubble jet). The print is dried completely and fixed in saturated steam at 102° C. for 8 minutes, cold-rinsed, washed off at the boil, rinsed again and dried.

What is claimed is:

1. A dye mixture comprising at least one dye of formula 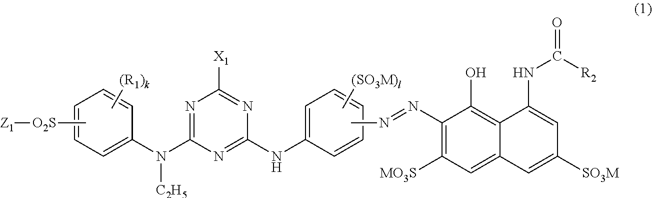
and at least one dye selected from the group consisting of formulae 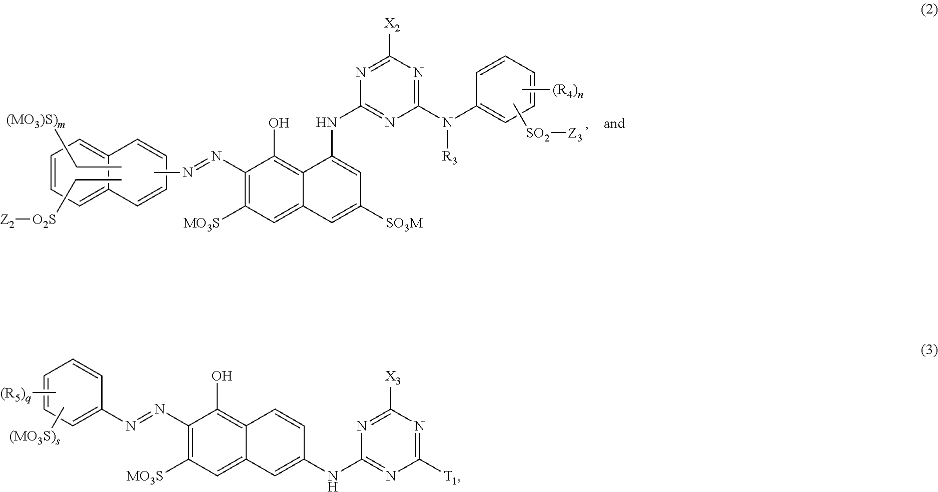
wherein
(R₁)ₖ denotes k identical or different substituents from the group C₁-C₄ alkoxy, C₁-C₄ alkyl and sulfo,
R₂ is hydrogen or C₁-C₄ alkyl,
R₃ is hydrogen or C₁-C₄ alkyl,
(R₄)ₙ denotes n identical or different substituents from the group C₁-C₄ alkoxy, C₁-C₄ alkyl and sulfo,
(R₅)_{q} denotes q identical or different substituents from the group C₁-C₄ alkoxy and C₁-C₄ alkyl,
X₁, X₂ and X₃ are each independently of the others halogen, 3-carboxypyridin-1-yl or 3-carbamoylpyridin-1-yl,
T₁ is a fibre-reactive radical of formula 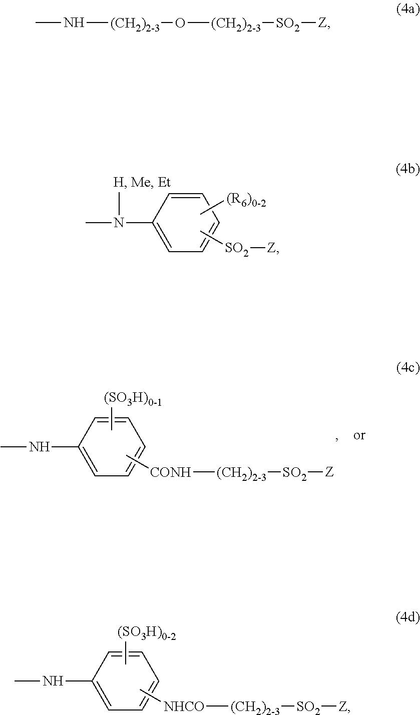
wherein
(R₆)₀₋₂ denotes from 0 to 2 identical or different substituents from the group C₁-C₄ alkyl, C₁-C₄ alkoxy and sulfo,
Me means methyl, and Et means ethyl,
Z, Z₁, Z₂ and Z₃ are each independently of the others vinyl or a radical —CH₂—CH₂—U and U is a group removable under alkaline conditions,
M is hydrogen, an alkali metal or one equivalent of an alkaline earth metal,
k, n and q are each independently of the others the number 0, 1 or 2, and
l, m and s are each independently of the others the number 1 or 2.

2. A dye mixture according to claim 1, wherein k and n each are the number 0.

3. A dye mixture according to claim 1, wherein R₂ is methyl, ethyl or propyl.

4. A dye mixture according to claim 1, wherein R₃ is ethyl.

5. A dye mixture according to claim 1, wherein (R₅)_{q} denotes 1 or 2 identical or different substituents from the group methoxy and methyl.

6. A dye mixture according to claim 1, wherein X₁, X₂ and X₃ are each halogen.

7. A dye mixture according to claim 1, wherein T₁ is a fibre-reactive radical of formula 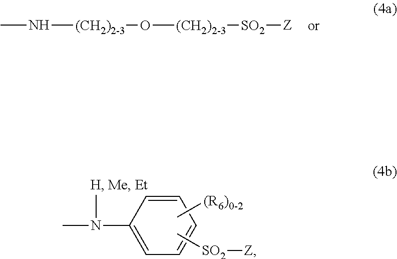
wherein
Me means methyl, and Et means ethyl,
(R₆)₀₋₂ denotes from 0 to 2 identical or different substituents from the group methoxy, methyl and sulfo, and
Z is vinyl, β-sulfatoethyl or β-chloroethyl.

8. A dye mixture according to claim 7, wherein T₁ is a fibre-reactive radical of formula (4a).

9. A dye mixture according to claim 1, wherein m is the number 1.

10. A dye mixture according to claim 1, wherein s is the number 2.

11. A dye mixture according to claim 1, wherein the dye of formula (1) corresponds to a dye of formula 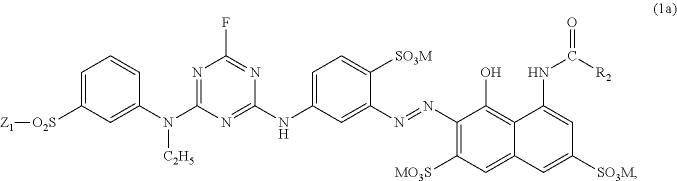
wherein
R₂ is methyl, ethyl or propyl,
M is hydrogen, an alkali metal or one equivalent of an alkaline earth metal, and
Z₁ is vinyl or β-sulfatoethyl.

12. A method for the dyeing or printing of hydroxy-group-containing or nitrogen-containing fibre materials, which method comprises using a dye mixture according to claim 1.

13. A method according to claim 12, wherein cellulosic fibre material, especially cotton-containing fibre material, is dyed or printed.

14. A reactive dye of formula 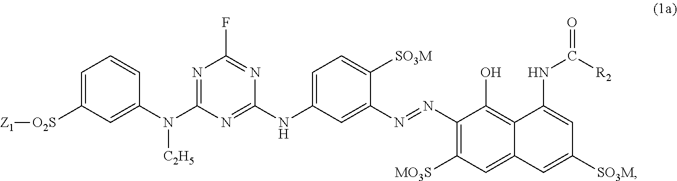
wherein
R₂ is methyl, ethyl or propyl,
M is hydrogen, an alkali metal or one equivalent of an alkaline earth metal, and
Z₁ is vinyl or β-sulfatoethyl.
